(19) United States
(12) Patent Application Publication
(10) Pub. No.: US 2022/0010040 A1
(43) Pub. Date: Jan. 13, 2022

(54) REMOVAL OF THIOCARBONYLTHIO END GROUPS FROM POLYMERS

(71) Applicant: King Abdullah University of Science and Technology, Thuwal (SA)

(72) Inventors: Xiaoshuang FENG, Thuwal (SA); Prakash ALAGI, Thuwal (SA); Yves GNANOU, Thuwal (SA); Nikos HADJICHRISTIDIS, Thuwal (SA)

(21) Appl. No.: 17/293,339

(22) PCT Filed: Nov. 14, 2019
(86) PCT No.: PCT/IB2019/059798

§ 371 Date: May 12, 2021

Related U.S. Application Data
(60) Provisional application No. 62/800,653, filed on Feb. 4, 2019.
(60) Provisional application No. 62/767,112, filed on Nov. 14, 2018.

(51) Int. Cl. C08F 8/00; C08F 2/38; C08F 220/14; C08F 212/08; C08F 218/08; C08F 226/10; C08K 5/39; C08K 5/38; C08K 5/55

(52) U.S. Cl. CPC C08F 8/00; C08F 2/38; C08F 220/14; C08F 212/08; C08F 218/08; C08F 2810/40; C08K 5/39; C08K 5/38; C08K 5/55; C08F 2438/03; C08F 226/10

(57) ABSTRACT

Embodiments of the present disclosure describe a method of removing an end group from a polymer comprising contacting a polymer having a thiocarbonylthio end group, or a solution containing such a polymer, with an excess of a borane compound in the presence of oxygen. Embodiments of the present disclosure further describe a method of polymerization comprising contacting one or more monomers with an initiator and a chain transfer agent to form a polymer having a thiocarbonylthio end group in a reaction solution and contacting the polymer with a borane compound in the presence of oxygen to remove the thiocarbonylthio end group from the polymer.

### BACKGROUND

Reversible addition-fragmentation chain transfer (RAFT) is one of the most versatile controlled radical polymerization techniques. It enables the controlled synthesis of a wide range of polymers with various functionalities and architectures. In RAFT polymerizations, the growing radical repeatedly undergoes degenerative transfers in the presence of thiocarbonylthio chain transfer agents (CTA), such as dithioesters (DTE), trithiocarbonates (TTC), dithiocarbamates (DTC), and xanthates (XAN), becoming dormant before being active again upon activation by another entering radical. At the end of polymerization, the thiocarbonylthio groups that were initially carried by the CTA are part of the synthesized polymer fitting their chain ends. They are responsible for the “living” and controlled growth of the chains, but their presence at chain ends under conditions for commercial applications is often undesirable as they impart color, bad odor, and toxicity to the polymers carrying them. The elimination of these thiocarbonylthio moieties and their related toxic sulfur residues entails an extra cost with additional steps which have been significant obstacles to broad commercialization of the RAFT technology.

Several strategies have been considered to remove this sulfur-containing end groups from the RAFT-prepared polymers. As summarized in FIG. 1A, the latter groups can be displaced by nucleophilic reactions, Diels-Alder reaction, radical-induced reaction, or thermolysis. The first two methodologies do not result in thiocarbonylthio removal or in desulfurization of the polymer. Rather, they merely transform the end groups carried by these RAFT-synthesized polymers into other sulfur-containing functional groups. While thermolysis may achieve complete end-group removal, it necessitates high temperatures (120° C.-200° C.), long residence times, and results in the formation of unsaturated end groups that may further undergo side reactions.

Radical-induced reactions also provide an option for the elimination of the thiocarbonylthio end groups as detailed in FIG. 1B. The radicals generated from these processes induce the cleavage of the C—S bond upon addition to the thiocarbonylthio end group. One report used azobisisobutyronitrile (AIBN) as radical source for the removal of DTE end groups from poly(methyl methacrylate). Combining AIBN with lauryl peroxide works for styrenic and acrylic type polymers. Other radical sources, such as hydrogen peroxide and alkoxyamine have also been used for the effective cleavage of DTE- and TTC-prepared polymers. In some cases, in addition to the radical source, H-donor additives, such as tributyltin hydride, tris(trimethylsilyl)silane, and N-ethylpiperidine hypophosphite are necessary to promote the cleavage reaction. Another report demonstrated that a light-mediated method can also be used to remove thiocarbonylthio end groups from RAFT-prepared polymers with the aid of 10-phenylphenothiazine along with formic acid and tributyamine. Another report relies on ultraviolet (UV) light to cleave the thiocarbonylthio group in the presence of H-donors. All reported examples involving radical-induced process thus require either high temperatures or long reaction times, and additives to achieve the end group removal from the polymers prepared by RAFT methodology.

### SUMMARY

In general, embodiments of the present disclosure describe methods of removing end groups from polymers, methods of polymerization, and the like.

Embodiments of the present disclosure describe a method of removing an end group from a polymer comprising contacting a polymer having a thiocarbonylthio end group, or a solution containing such a polymer, with an excess of a borane compound in the presence of oxygen.

Embodiments of the present disclosure further describe a method of polymerization comprising contacting one or more monomers with an initiator and a chain transfer agent to form a polymer having a thiocarbonylthio end group in a reaction solution and contacting the polymer with a borane compound in the presence of oxygen to remove the thiocarbonylthio end group from the polymer.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIGS. 1A-1B are schematic diagrams of conventional processes of (A) RAFT end-group removal or transformation and (B) RAFT end-group removal based on radical-induced reactions.

FIG. 2 is a flowchart of a method of removing an end group from a polymer, according to one or more embodiments of the present disclosure.

FIG. 3 is a flowchart of a method of polymerization, according to one or more embodiments of the present disclosure.

FIG. 4 is a schematic diagram of the radical-induced end-group removal using a borane compound and oxygen, according to one or more embodiments of the present disclosure.

FIG. 5 is a general reaction scheme for synthesis of RAFT polymer and the removal of respective end groups, according to one or more embodiments of the present disclosure.

FIGS. 6A-6F show: (A) UV-vis absorption spectra, (B) ¹H NMR spectra, (C) GPC traces, (D) MALDI-TOF spectra of PMMA-DTE, (E) MALDI-TOF spectra of PMMA-T, and (F) Thermogravimetric analysis (TGA) of PMMA-DTE before and after treatment with TEB and O₂, according to one or more embodiments of the present disclosure.

FIGS. 7A-7F show: (A)¹H NMR spectra, (B) GPC traces, (C) MALDI-TOF spectra of PS-TTC, (D) MALDI-TOF spectra of PS-T, (E) UV-vis absorption spectra, and (F) TGA for PS-TTC before and after treatment with TEB/O₂, according to one or more embodiments of the present disclosure.

FIGS. 8A-8E show: (A)¹H NMR spectra, (B) GPC traces, (C) MALDI-TOF spectra of PVAc-DTC, (D) MALDI-TOF spectra of PVAc-T, and (E) UV-vis absorption spectra, of PVAc-DTC before and after TEB/O₂ treatment, according to one or more embodiments of the present disclosure.

FIGS. 9A-9E show: (A)¹H NMR spectra, (B) UV-vis absorption spectra, of PNVP-XAN before and after TEB/O₂ treatment, (C) MALDI-TOF spectra of PNVP-XAN, (D) MALDI-TOF spectra of PNVP-T, and (E) UV-vis absorption spectra, of PNVP-XAN before and after TEB/O₂ treatment, according to one or more embodiments of the present disclosure.

FIGS. 10A-10H shows MALDI-TOF spectra for PMMA-DTE, PS-TTC, PVAc-DTC, and PNVP-XAN before and after TEB/O₂ treatment, according to one or more embodiments of the present disclosure.

FIG. 11 presents a table summarizing MALDI-TOF peaks abbreviations, structure, and molar mass (m/z) details before and after TEB/O₂ treatment, according to one or more embodiments of the present disclosure.

FIG. 12 is a general reaction scheme depicting the elimination mechanism of CTA using TEB-oxygen, according to one or more embodiments of the present disclosure.

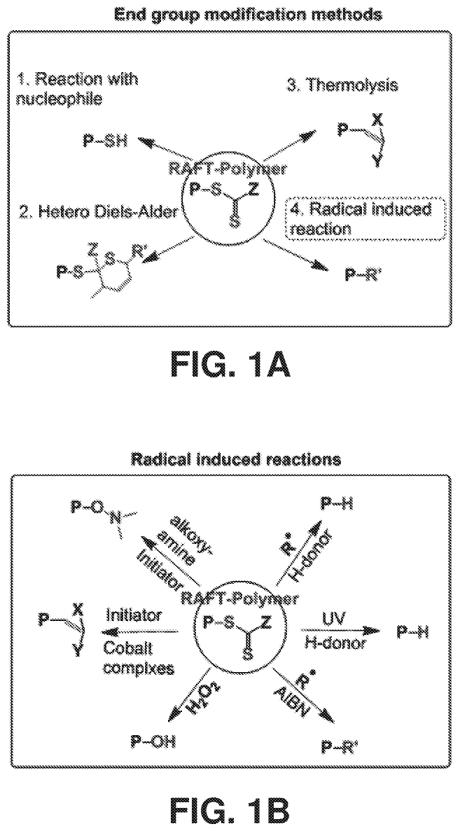

### DETAILED DESCRIPTION

### Definitions

As used herein, the term “heteroatom” refers to any element other than carbon or hydrogen. Non-limiting examples of heteroatoms include nitrogen, oxygen, sulfur, phosphorus, and silicon. Each heteroatom may optionally comprise any substituent which satisfies the valences of the heteroatoms.

As used herein, the term “alkyl” refers to a branched or unbranched saturated hydrocarbon radical or moiety comprising only carbon and hydrogen atoms and having 50 or fewer carbon atoms. The term includes cycloalkyl radicals or groups. Non-limiting examples of alkyls include methyl, ethyl, n-propyl, isopropyl, n-butyl, isobutyl, t-butyl, octyl, decyl, cyclopropyl, cyclobutyl, cyclopentyl, cyclohexyl, and the like. A “heteroalkyl” refers to an alkyl as defined above, including cycloalkyls, in which at least one carbon atom is replaced by a heteroatom. Alkyls may optionally be substituted with one or more substituents.

As used herein, the term “alkenyl” refers to a straight- or branched-chain hydrocarbon radical or moiety having 50 or fewer carbon atoms and at least one carbon-carbon double bond, which can be internal or terminal. Non-limiting examples of alkenyls include ethenyl, n-propenyl, isopropenyl, n-butenyl, isobutenyl, octenyl, decenyl, and the like. Alkenyls may include a heteroatom and may optionally be substituted with one or more substituents.

As used herein, the term “aryl” refers to a monocyclic or polycyclic aromatic hydrocarbon radical or moiety comprising only carbon and hydrogen atoms and having 150 or fewer carbon atoms, wherein the carbon atoms form a single aromatic ring or multiple aromatic rings fused together, linked covalently, or linked to a common group. Examples of common groups include, methylene, ethylene, a carbonyl (e.g., benzophenone), an oxygen atom (e.g., diphenylether), or a nitrogen atom (e.g., diphenylamine). Non-limiting examples of aryls include phenyl, naphthyl, biphenyl, diphenylether, diphenylamine, benzophenone, and the like. A “heteroaryl” refers to an aryl as defined above in which at least one carbon atom is replaced by a heteroatom. Aryls may optionally be substituted with one or more substituents (e.g., tolyl, mesityl, and perfluorophenyl).

As used herein, the term “aralkyl” refers to an alkyl with an aryl substituent. The term “aralkylene” refers to an alkylene with an aryl substituent. The term “alkaryl” refers to an aryl with an alkyl substituent. The term “alkarylene” refers to an arylene with an alkyl substituent. The alkyl, aryl, or both may optionally be substituted with one or more substituents.

As used herein, the term “alkoxy” refers to the group —OR, wherein R is an alkyl or heteroalkyl as defined above. The alkyl and heteroalkyl may independently and optionally be substituted with one or more substituents. The terms “alkenyloxy,” “alkynyloxy,” “aryloxy,” “aralkoxy,” “heteroaryloxy,” and “acyloxy” refer to the group OR, wherein R is an alkenyl, alkynyl, aryl, aralkyl, heteroaryl, and acyl, respectively, as those terms are defined herein. The alkenyl, alkynyl, aryl, aralkyl, heteroaryl, and acyl may independently and optionally be substituted with one or more substituents.

As used herein, the term “acyl” refers to the group —C(O)R, wherein R is a hydrogen, alkyl, aryl, aralkyl, or heteroaryl as those terms are defined above. The alkyl, aryl, aralkyl, and heteroaryl may independently and optionally be substituted with one or more substituents.

As used herein, the term “aroyl” refers to the group —C(═O)R, wherein R is an aryl as defined above. Non-limiting examples of aroyls include benzoyl and toluoyl. The aryl may optionally be substituted with one or more substituents.

As used herein, the term “alkylsulfonyl” refers to the group —S(O)₂R, where R is an alkyl. The term “arylsulfonyl” refers to the group —S(O)₂R, where R is an aryl. The alkyl and aryl may optionally be substituted with one or more substituents.

As used herein, the term “alkylphosphonyl” refers to the group —P(═O)(OR)₂ or —OP(═O)(OR)₂, where each R is independently an alkyl or heteroalkyl. The alkyl and heteroalkyl may independently and optionally be substituted with one or more substituents.

As used herein, the term “arylphosphonyl” refers to the group —P(═O)(OR)₂ or —OP(═O)(OR)₂, where each R is independently an aryl or heteroaryl. The aryl and heteroaryl may independently and optionally be substituted with one or more substituents.

As used herein, the term “ether” refers to the group —O—.

As used herein, the term “silyl” refers to —SiQ¹W²X³ radical, where each of Q¹, W², and X³ is independently selected from the group consisting of hydrido and optionally substituted alkyl, alkenyl, alkynyl, aryl, aralkyl, alkaryl, heterocyclic, alkoxy, aryloxy and amino.

As used herein, the term “hydrocarbyl” refers to univalent hydrocarbyl radicals containing 1 to about 50 carbon atoms, such as 1 to about 24 carbon atoms or 1 to about 12 carbon atoms, including branched or unbranched, saturated or unsaturated species, such as alkyl groups, alkenyl groups, aryl groups, and the like. Hydrocarbyls may include a heteroatom and may optionally be substituted with one or more substituents.

As used herein, the terms “halo,” “halogen,” and the like refer to —Cl, —Br, —I, —F, and the like.

As used herein, “substituted” refers to any moiety in which at least one hydrogen atom bound to a carbon atom is replaced by one or more substituents. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, azido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, and the like.

The invention of the present disclosure relates to, among other things, methods for removing thiocarbonylthio end groups from polymers prepared by reversible addition-fragmentation chain transfer (RAFT) polymerization. RAFT-synthesized polymers, or more simply RAFT polymers, can be represented by general formula (I):

P—SC(═S)Z (I)

wherein P is any polymer and SC(═S)Z is a generic thiocarbonylthio end-group. The presence of thiocarbonylthio groups at chain ends can impart undesirable color, odor, and toxicity to the RAFT polymers. Accordingly, it is often desirable to remove the end groups entirely. While a number of methods are presently known in the art, such conventional methods are limited in that they either (1) only transform the end group into a different functional group and thus do not (and cannot) remove or desulfurize the end group completely or (2) require high temperatures and/or long reaction times in order for the end group to be completely removed.

Embodiments of the present disclosure describe methods for removing thiocarbonylthio end groups from RAFT polymers that overcome the aforementioned challenges and limitations of conventional methods. The methods can proceed by contacting a RAFT polymer with a borane compound in the presence of oxygen. The methods can advantageously remove the end group in its entirety from the polymer, under moderate conditions (e.g., moderate temperatures) and in much shorter reaction times relative to conventional methods. The methods can also be performed in situ, e.g., at the end of a RAFT polymerization, in a simple one-pot procedure and/or in a solution of a RAFT-synthesized polymer. The methods thus do not require, as an initial step, isolating the RAFT polymer prior to performing the method. Instead, the method can be performed using the same solvent or solvent system as that which is used to form the RAFT polymer. In addition, the removal of the end group from the polymer can be observed visually, in many instances within about 1 min or less, as evidenced by decolorization of the reaction solution. The methods described herein are general, with broad applicability, and thus can be used in connection with RAFT-synthesized polymers or any polymers having a thiocarbonylthio end group.

While not wishing to be bound to a theory, it is believed that, the borane compound can serve dual roles of radical generator and H-donor in the process of cleaving a thiocarbonylthio end group from a polymer and neutralizing the cleaved compound into a colorless thioester. For example, it is believed that, upon being exposed to oxygen, the borane compound generates highly reactive radicals very quickly through autoxidation. These radicals immediately add to the —C═S bond of the thiocarbonylthio end group on the polymer to generate an intermediate that undergoes fragmentation and produces a polymer radical and a new thiocarbonylthio compound. The borane compound is provided in excess to provide additional radicals which are available for reaction with the newly formed polymer radical and thiocarbonylthio compound. In particular, the excess radicals can react with the polymer radical to form H-terminated polymers through dismutation and, optionally or at least to a lesser extent, R- and/or ROO-terminated polymers through recombination and other polymers through bimolecular termination (e.g., where R can be R¹ as described below). The excess radicals can react with the new thiocarbonylthio compound to neutralize it into colorless thioesters.

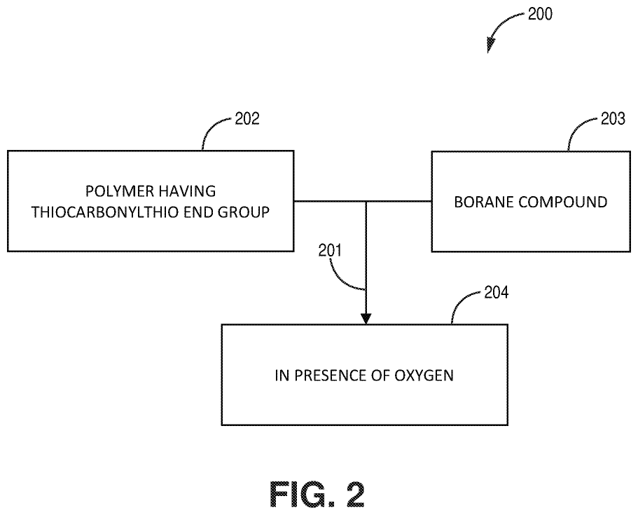

FIG. 2 is a flowchart of a method of removing a thiocarbonylthio end group from a polymer, according to one or more embodiments of the present disclosure. As shown in FIG. 2, the method 200 comprises contacting 201 a polymer having a thiocarbonylthio end group 202, or a solution containing such a polymer, with an excess of a borane compound 203 in the presence of oxygen 204. As used herein, the term “polymer having a thiocarbonylthio end group” refers broadly to any polymers having a thiocarbonylthio group at a chain or terminal end of the polymer. As polymers synthesized by RAFT polymerization generally comprise thiocarbonylthio end groups, the term “polymer having a thiocarbonylthio end group” may, at times herein, be used interchangeably with “RAFT polymer” or “RAFT-synthesized polymer.” However, such use shall not be construed as limiting the term “polymer having a thiocarbonylthio end group” to refer only to RAFT or RAFT-synthesized polymers.

The contacting can proceed in any manner suitable for bringing the polymer, borane compound, and oxygen into physical contact, or immediate or close proximity. In many embodiments, the contacting can be performed in situ, following a RAFT polymerization, using the same solvent system as that which was used to carry out the polymerization reaction. For example, the contacting can proceed by adding a borane compound to a solution in which the polymer was formed and then exposing the solution to oxygen or any source of oxygen (e.g., oxygen in air), by stirring, among other techniques. The contacting can be performed without performing any intermediate step in which the polymer is first separated or isolated from the reaction solution. In other embodiments, the contacting can be performed using a solvent system that is different from the one in which it was formed. For example, the contacting can proceed by adding a borane compound to any solution containing the polymer and then exposing the solution to oxygen.

The conditions under which the contacting is performed are not particularly limited. In particular, the entire reaction can proceed independent of temperature. Unlike conventional processes in which radical generation is temperature sensitive, the generation of radicals according to the methods of the present disclosure are not temperature sensitive. For example, the autoxidation reaction involving the borane compound in the presence of oxygen can exhibit no temperature dependence (i.e., the reaction can be temperature independent). Accordingly, the contacting can be performed across any range of temperatures. As moderate temperatures are convenient and low-cost, the contacting can be performed at ambient temperature, such as about room temperature.

The borane compound can be selected from alkyl boranes and aryl boranes. In an embodiment, the borane compound is a trialkyl borane or a triaryl borane. For example, the borane compound can be represented by general formula (II):

B(R¹)₃ (II)

wherein each R¹ is independently selected from alkyls and aryls, wherein the alkyls are selected from linear or branched alkyl groups, aromatic or non-aromatic alkyl groups, and carbocyclic or heterocyclic alkyl groups, each of which can be substituted or unsubstituted; wherein the aryls are selected from aryl groups and heteroaryl groups, each of which can be substituted or unsubstituted. In one embodiment, each R¹ is selected from an ethyl, n-butyl, i-butyl, n-octyl, and phenyl group. For example, suitable borane compounds can include, but are not limited to, triethyl borane, tributyl borane, triisobutyl borane, trioctyl borane, and triphenyl borane.

The borane compound can be provided in an amount sufficient to drive the reaction towards a desired product and/or to avoid bimolecular termination (e.g., a polymer in which the thiocarbonylthio compound is removed and replaced with a hydrogen and/or removed and neutralized thiocarbonylthio compound/group). For example, the borane compound can be provided in molar excess of the chain transfer agent that was used to carry out a RAFT polymerization. In one embodiment, a molar ratio of the borane compound to the chain transfer agent is about 5:1, or greater. In other embodiments, any amount of the borane compound that is in excess of the chain transfer agent can be used. For example, the molar ratio of the borane compound to the chain transfer agent can range from about 1.01:1 to about 10:1, or even greater in some instances. Examples of molar ratios of the borane compound to the chain transfer agent can include, but are not limited to, about 1.01:1, about 2:1, about 3:1, about 4:1, about 5:1, about 6:1, about 7:1, about 8:1, about 9:1, about 10:1, or any increment thereof.

The oxygen to which the borane compound is exposed can be provided from any source. A free and convenient source of oxygen is air; however, other sources can be used, such as purified or pure oxygen, among others, without departing from the scope of the present disclosure.

The thiocarbonylthio end group provided at a chain end of the polymer and removed therefrom can be represented by general formula (III):

—SC(═S)Z (III)

wherein Z can be any functional group that binds to C═S through, for example, a C, N, S, O, or P atom. In an embodiment, Z can be selected from —R², —N(R²)₂, —SR², —OR², and —P(O)(OR²)₂, wherein each R² can be independently selected from substituted and unsubstituted hydrocarbyls and substituted and unsubstituted heteroatom-containing hydrocarbyls. For example, each R² can be independently selected from one or more of hydrogen, alkyls, heteroalkyls, aralkyls, heteroaralkyls, aryls, heteroaryls, alkenyls, acyls, aroyls, alkoxys, heterocyclyls, alkylsulfonyls, arylsulfonyls, alkylphosphonyls, and arylphosphonyls, each of which can be substituted or unsubstituted. For example, each R² can be independently selected from -Ph, —CH₃, —CH₂CH₃, —C₁₂H₂₅, and cyclic compounds, among others. The substituents are not particularly limited and can be selected from alkyl, aryl, ether, halogens (e.g., Cl, Br, F, etc.), OH, COOH, and silyl substituents, among others. Non-limiting examples of various functional groups Z are provided below in Tables 1 through 4.

TABLE 1
EXAMPLES OF FUNCTIONAL GROUPS FROM DITHIOESTERS

| Functional Group (Z) | No. |
|---|---|
| 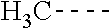 | (1) |
| 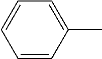 | (2) |
| 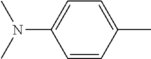 | (3) |
| 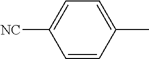 | (4) |
| 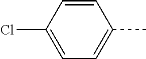 | (5) |
| 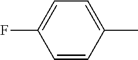 | (6) |
| 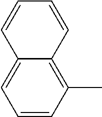 | (7) |
| 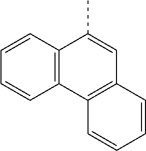 | (8) |
| 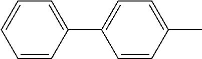 | (9) |
| 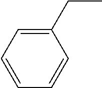 | (10) |
| 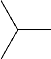 | (11) |

TABLE 2
EXAMPLES OF FUNCTIONAL GROUPS FROM
TRITHIOCARBONATES

| Functional Group (Z) | No. |
|---|---|
| 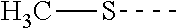 | (12) |
| 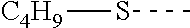 | (13) |
| 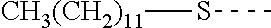 | (14) |
| 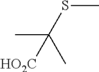 | (15) |
| 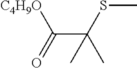 | (16) |
| 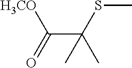 | (17) |
| 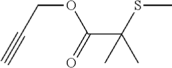 | (18) |
| 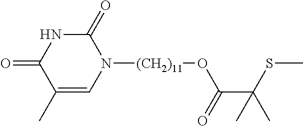 | (19) |
| 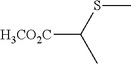 | (20) |
| 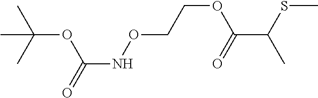 [SMILES: CSC(C)C(=O)OCCONC(=O)OC(C)(C)C] | (21) |
| 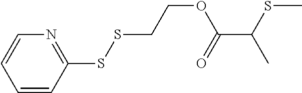 [SMILES: CSC(C)C(=O)OCCSSc1ccccn1] | (22) |
| 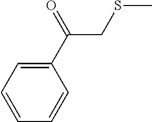 | (23) |
| 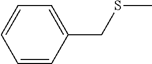 | (24) |
| 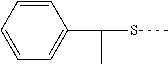 | (25) |
| 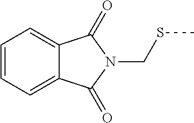 | (26) |
| 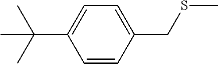 | (27) |
| 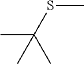 | (28) |
| 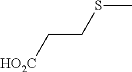 | (29) |

TABLE 3
EXAMPLES OF FUNCTIONAL GROUPS FROM XANTHATES

| Functional Group (Z) | No. |
|---|---|
| 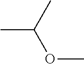 | (30) |
| 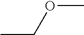 | (31) |
| 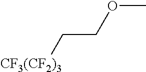 | (32) |
| 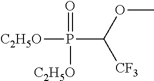 | (33) |
| 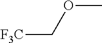 | (34) |
| 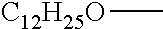 | (35) |
| 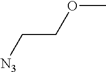 | (36) |
| 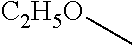 | (37) |
| 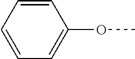 | (38) |
| 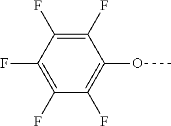 | (39) |

TABLE 4
EXAMPLES OF FUNCTIONAL GROUPS FROM
DITHIOCARBAMATES

| Functional Group (Z) | No. |
|---|---|
| 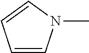 | (40) |
| 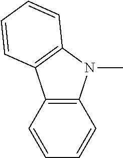 | (41) |
| 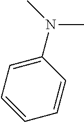 | (42) |
| 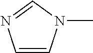 | (43) |
| 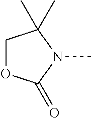 | (44) |
| 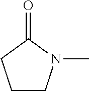 | (45) |
| 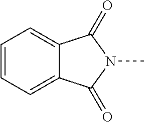 | (46) |
| 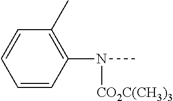 | (47) |
| 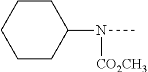 | (48) |
| 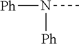 | (49) |
| 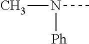 | (50) |
| 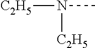 | (51) |
| 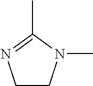 | (52) |
| 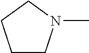 | (53) |
| 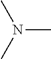 | (54) |
| 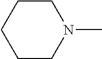 | (55) |
| 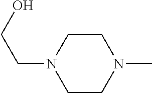 | (56) |
| 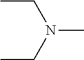 | (57) |
| 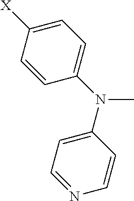 | (58) |

wherein X is selected from OCH₃, H, F, and CN;

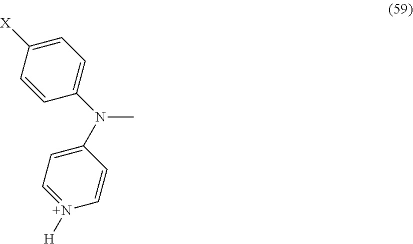

wherein X is selected from OCH₃, H, F, and CN;

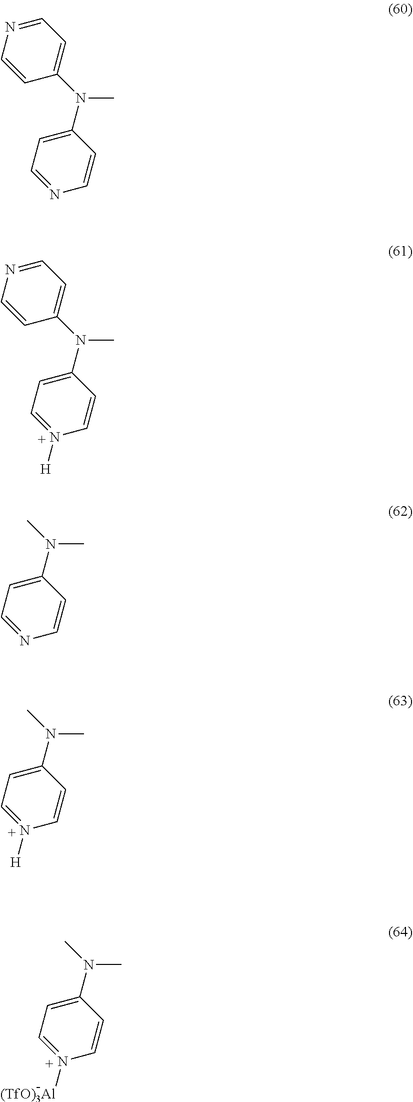

The discussion of the thiocarbonylthio end groups and the examples provided herein shall not be limiting as other examples are known in the art. See, for example, the following for a listing of thiocarbonylthio end groups and their functional groups Z in the context of RAFT polymerizations, which are incorporated by reference in their entirety: Moad et al., Aust. J. Chem., 2005, 58(6), 379-410; Moad et al., Aust. J. Chem., 2006, 59, 669-692; Moad et al., Aust. J. Chem., 2009, 62, 1402-1472; and Moad et al., Aust. J. Chem., 2012, 65(8), 985-1076.

The polymer, P, is not particularly limited and thus can be any polymer having a thiocarbonylthio end group, such as polymers prepared by RAFT polymerization. The polymers can include linear polymers and non-linear polymers, and homopolymers and copolymers. The polymers can have a variety of architectures. For example, the polymers can be provided as block copolymers, star polymers, gradient polymers, brush polymers, branched polymers, and graft polymers, among others. The polymers can also be selected from various polymer categories, such as styrenes, acrylates, acrylamides, methacryltes, methacrylamides, vinyl esters, and vinyl amides, among others. Examples of other polymers for use herein are described below and also others are known in the art.

While not wishing to be bound to a theory, it is believed that, following removal of the thiocarbonylthio end group from the polymer, a polymer radical, P*, and a new thiocarbonylthio compound can be formed. The new thiocarbonylthio compound can react with excess radicals (e.g., R¹*, wherein R¹* is a radical from the borane compound generated by autoxidation) and be neutralized into colorless sulfur product. For example, in an embodiment, the neutralized compound can have the formula: R¹—SC(Z)S—R¹, wherein R¹ is a functional group from the borane compound. The polymer radical can react with excess radicals to form, as a major product, H-terminated polymers through, for example, dismutation. In some embodiments, the polymer radical can react with excess radicals to form, as minor products, R¹-terminated polymers and/or R¹OO-terminated polymers through recombination, wherein R¹ is a functional group from the borane compound. In some embodiments, the polymer radicals can react through biomolecular termination. Typically, the major products comprise a majority fraction of the products (e.g., greater than 50% of products), with the balance including minor products and colorless thioesters, among others.

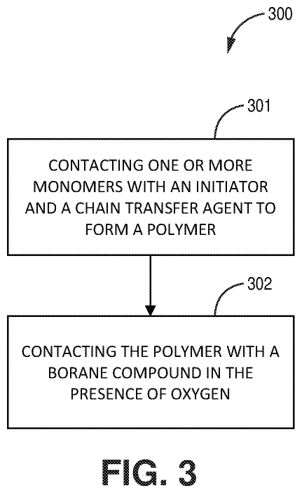

FIG. 3 is a method of polymerization, according to one or more embodiments of the present disclosure. As shown in FIG. 3, the method 300 can comprise one or more of the following steps: contacting 301 one or more monomers with an initiator and a chain transfer agent to form a polymer (e.g., a RAFT polymer) having a thiocarbonylthio end group in a reaction solution and contacting 302 the polymer (e.g., the RAFT polymer) with a borane compound in the presence of oxygen to remove the thiocarbonylthio end group from the RAFT polymer.

In step 301, a RAFT polymer having a thiocarbonylthio end group is formed by reversible addition-fragmentation chain transfer (RAFT) polymerization. The step 301 can be performed by contacting one or more monomers with an initiator and a chain transfer agent. The monomers, initiators, and chain transfer agents suitable for use in this step are not particularly limited. For example, any of the monomers, initiators, and chain transfer agents used in RAFT polymerizations and/or known in the art can be used. The contacting generally proceeds by bringing the one or more monomers, initiator, and chain transfer agent into physical contact, or immediate or close proximity, in a solvent. For example, in an embodiment, the contacting can proceed by dissolving the one or more monomers, initiator, and chain transfer agent in a solvent. The conditions under which the contacting proceeds are not particularly limited and can include any conditions known in the art suitable for RAFT polymerizations.

Examples of monomers suitable for the methods described herein can include, but are not limited to, one or more of methyl methacrylate, ethyl methacrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methylstyrene, methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile, styrene, functional methacrylates, acrylates and styrenes selected from glycidyl methacrylate, 2-hydroxyethyl methacrylate, hydroxypropyl methacrylate (all isomers), hydroxybutyl methacrylate (all isomers), methyl α-hydroxymethyacrylate, ethyl α-hydroxymethyacrylate, butyl α-hydroxymethyacrylate, N,N-dimethylaminoethyl methacrylate, N,N-diethylaminoethyl methacrylate, triethyleneglycol methacrylate, itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoethyl acrylate, triethyleneglycol acrylate, methacrylamide, N-methylacrylamide N,N-dimethylacrylamide, N-tert-butylmethacrylamide, N-n-butylmethacrylamide, N-methylolmethacrylamide, N-ethylolmethacrylamide, N-tert-butylacrylamide, N-n-butylacrylamide, N-methylolacrylamide, N-ethylolacrylamide, vinyl benzoic acid (all isomers), diethylaminostyrene (all isomers), alpha-methylvinyl benzoic acid (all isomers), diethylamino alpha-methylstyrene (all isomers). p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxymethylsilylpropyl methacrylate, diethoxymethyl-silylpropylmethacrylate, dibutoxymethylsilylpropyl methacrylate, diisopropoxymethylsilylpropyl methacrylate, dimethoxysilylpropyl methacrylate, diethoxysilyipropyl methacrylate, dibutoxysilylpropyl methacrylate, diisopropoxysilylpropyl methacrylate, trimethoxysilylpropyl acrylate, triethoxysilylpropyl acrylate, tributoxysilylpropyl acrylate, dimethoxymethylsilylpropyl acrylate, diethoxymethylsilyipropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, butadiene, isoprene, chloroprene, ethylene and propylene. This list of monomers shall not be limiting as any monomer(s) known in the art that can be polymerized by reversible addition-fragmentation chain transfer polymerization can be used herein.

Examples of initiators, which are optional, suitable for the methods described herein can include, but are not limited to, one or more of alkyl peroxides, substituted alkyl peroxides, aryl peroxides, substituted aryl peroxides, acyl peroxides, alkyl hydroperoxides, substituted alkyl hydroperoxides, aryl hydroperoxides, substituted aryl hydroperoxides, heteroalkyl peroxides, substituted heteroalkyl peroxides, heteroalkyl hydroperoxides, substituted heteroalkyl hydroperoxides, heteroaryl peroxides, substituted heteroaryl peroxides, heteroaryl hydroperoxides, substituted heteroaryl hydroperoxides, alkyl peresters, substituted alkyl peresters, aryl peresters, substituted aryl peresters, peracids, percarbonates, alkyl peroxalates, alkylperoxidicarbonates, alkyl ketone peroxides, persulphates, azo compounds and halide compounds. In some embodiments, the initiators can be selected from 2,2′-azobis(isobutyronitrile), 2,2′-azobis(2-cyano-2-butane), dimethyl 2,2′-azobis(methyl isobutyrate), 4,4′-azobis(4-cyanopentanoic acid), 4,4′-azobis(4-cyanopentan-1-ol), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl)]-propionamide, 2,2′-azobis(N,N′-dimethyleneisobutyramidine) dihydrochloride, 2,2′-azobis(2-amidinopropane) dihydrochloride, 2,2′-azobis(N,N′-dimethyleneisobutyramine), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide], 2,2′-azobis(isobutyramide) dihydrate, 2,2′-azobis(2,2,4-trimethylpentane), 2,2′-azobis(2-methylpropane), t-butyl peroxyacetate, t-butyl peroxybenzoate, t-butyl peroxyoctoate, t-butyl peroxyneodecanoate, t-butylperoxy isobutyrate, t-amyl peroxypivalate, t-butyl peroxypivalate, di-isopropyl peroxydicarbonate, dicyclohexyl peroxydicarbonate, dicumyl peroxide, dibenzoyl peroxide, dilauroyl peroxide, potassium peroxydisulfate, ammonium peroxydisulfate, di-t-butyl hyponitrite, dicumyl hyponitrite, and combinations thereof.

Examples of chain transfer agents, or RAFT agents, suitable for the methods described herein can include compounds having thiocarbonylthio end groups, such as dithioesters (DTE), trithiocarbonates (TTC), dithiocarbamates (DTC), xanthates (XAN), and other compounds. For example, the RAFT agents can have the following generic formula (IV):

R³—SC(═S)Z (IV)

wherein R³ is any functional group or group sufficiently labile to be expelled as its free radical form, and —SC(═S)Z can be provided as described above in connection with formula (III) and elsewhere in the present disclosure. Examples of R³ include, but are not limited to, alkyls, heteroalkyls, aryls, heteroaryls, aralkyls, heteroaralkyls, combinations thereof, and the like, each of which may independently optionally be branched and/or optionally substituted with one or more substituents. In an embodiment, Z can be selected from —R² (e.g., to provide dithioesters), —N(R²)₂ (e.g., to provide dithiocarbamates), —SR² (e.g., to provide trithiocarbonates), —OR² (e.g., to provide xanthates), and —P(O)(OR²)₂. The following references provide examples of RAFT agents and are hereby incorporated by reference in their entirety: Moad et al., Aust. J. Chem., 2005, 58(6), 379-410; Moad et al., Aust. J. Chem., 2006, 59, 669-692; Moad et al., Aust. J. Chem., 2009, 62, 1402-1472; Moad et al., Aust. J. Chem., 2012, 65(8), 985-1076; and U.S. Pat. Nos. 6,919,409 and 7,807,755.

In step 302, the thiocarbonylthio end group is removed from the RAFT polymer. The step 302 can be performed by contacting the RAFT polymer, or a solution containing such a polymer, with an excess of a borane compound in the presence of oxygen. The contacting performed in step 302, as well as the polymer, thiocarbonylthio end group, solution, borane compound, and oxygen are similar to or the same as that which is described in connection with FIG. 2 and elsewhere in the present disclosure. For example, in an embodiment, the step 302 can be performed in situ such that the borane compound is added to the reaction solution in which the RAFT polymer was formed and exposed to oxygen for the removal of the thiocarbonylthio end group from the RAFT polymer.

The borane compound is typically provided in molar excess of the chain transfer agent, or RAFT agent, used to carry out the RAFT polymerization (e.g., as described in step 301). In an embodiment, a ratio of the borane compound to the chain transfer agent is about 5:1. In other embodiments, any amount of the borane compound that is in excess of the chain transfer agent can be used. For example, in an embodiment, a ratio of the borane compound to the end group can be about 1.01:1, about 2:1, about 3:1, about 4:1, about 5:1, about 6:1, about 7:1, about 8:1, about 9:1, about 10:1, or any increment thereof.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### EXAMPLE

### Ultra-Fast and Efficient End Group Removal of RAFT-Synthesized Polymers Using Triethylborane and Oxygen

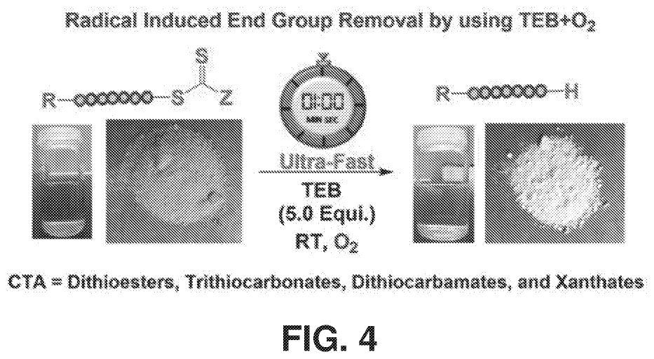

A rapid and efficient method to remove thiocarbonylthio end-groups from polymers prepared by reversible addition-fragmentation chain transfer (RAFT) is described herein. The elimination of these end-groups was achieved in less than one minute by treating the solution of RAFT-synthesized polymers with 5 eq. of triethylborane (TEB) under ambient temperature and in the presence of oxygen. See, for example, FIG. 4. The versatility of this method was verified on several RAFT-synthesized polymers using various thiocarbonylthio chain transfer agents (CTA) including dithioesters, trithiocarbonates, dithiocarbamates, and xanthates. UV, NMR, and MALDI-TOF characterization results all confirmed the complete removal of terminal CTA group.

### Materials and Characterization

Methyl methacrylate (MMA, Aldrich, 99%), Vinyl acetate (VAc, Aldrich, 99%), styrene (St, Aldrich, 99%), and N-Vinylpyrrolidone (NVP, Aldrich, 99%) were distilled under reduced pressure over calcium hydride prior to polymerization. RAFT agents includes 2-Cyano-2-propyl benzodithioate (DTE, Aldrich, 97%), Cyanomethyl dodecyl trithiocarbonate (TTC, Aldrich, 98%), Cyanomethyl methyl(phenyl)carbamodithioate (DTC, Aldrich, 98%) purchased from Aldrich and used without further purifications and (S)-2-(Ethyl propionate)-(O-ethyl xanthate) (XAN) was prepared as per literature report¹. Azobisisobutyronitrile (AIBN, Aldrich, 98%), was used as received. Tetrahydrofuran (THF) was distilled from sodium/benzophenone mixture before used. Triethyl borane (TEB) in THF solution (c=1M) was purchased from Aldrich and used without further purifications. The structures and acronyms of the CTAs and monomers used herein are provided below:

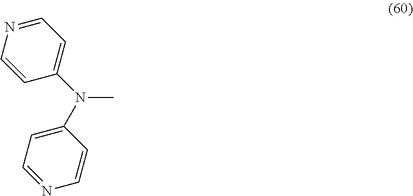

All ¹H NMR spectra were recorded on a Bruker AVANCE 111-400 Hz instrument in CD₂Cl₂. Gel permeation chromatography (GPC) were performed on a VISCOTEK VE2001 that was equipped with PSS columns (Styragel HR 2 and 4) using THF as an eluent at a flow rate of 1.0 mL/min. A narrow calibration curve to determine the molecular weight was obtained using a polystyrene standard. The molecular weight of Poly(vinyl pyrrolidone) was determined from GPC performed on Agilent liquid chromatography system using DMF as an eluent at flow rate of 1.0 mL/min and polystyrene as a standard. MALDI-TOF MS experiments were carried out by using trans-2-[3-(4-tert-butylphenyl)2-methyl-2-propenylidene]malononitrile (DCTB) as the matrix in THF and NaTFA as ionizing agent on a Bruker Ultrafex III MALDITOF mass spectrometer (Bruker Daltonik, Bremen, Germany) UV-visible absorption spectra were recorded between 200 and 600 nm using a Cary 60 UV-Vis spectrometer (Agilent, Santa Clara, USA). Measurements were conducted for RAFT-synthesized polymers before and after TEB/O₂ treatment in THF (0.25 mg mL⁻¹) in order to observe absorption maxima at 280 to 310 nm

### Methods

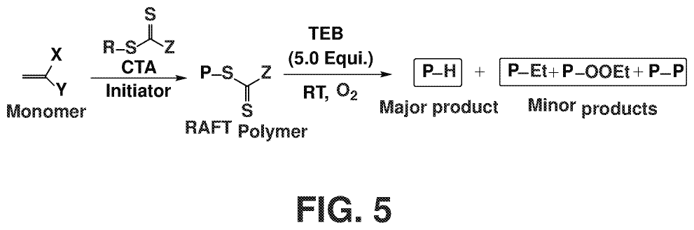

FIG. 5 shows a general reaction scheme for synthesis of RAFT polymer and the removal of respective end groups from PMMA-DTE, PS-TTC, PVAc-DTC, and PNVP-XAN, according to one or more embodiments of the present disclosure.

Representative procedure for preparation of poly(methyl methacrylate) with a dithiobenzoate (PMMA-DTE) and in-situ end group removal (Entry 1, Table 5, FIG. 5): MMA (2.00 g, 20.0 mmol), AIBN (6.5 mg, 0.04 mmol), and DTE (88.5 mg, 0.4 mmol) were dissolved in THF (2.0 mL) in a 50 mL Schlenk flask. The reaction flask was degassed with three freeze-evacuate-thaw cycles, sealed and submerged in a preheated oil bath (70° C.) for 18 h. The reaction solution was cooled to room temperature. The reaction solution was divided into two fractions. The first fraction (little quantity) was precipitated in n-hexane, the precipitated polymer was collected by centrifugation and dried in vacuum at 40° C. until constant weight to yield a pink color powder characteristic of polymer synthesized by RAFT polymerization using a DTE. The second fraction was subjected to a further reaction with TEB and O₂; TEB [2.0 mL, (1.0 Molar solution in THF), 2.0 mmol] was added directly to the polymerization mixture and the mixture was allowed to react for 1 min exposing to air till the decolorization (pink to colorless). After decolorization, the reaction mixture was precipitated in n-hexane, and the precipitated polymer was collected by centrifugation and dried in vacuum at 40° C. until constant weight.

Representative procedure for preparation of Poly(styrene) with trithiocarbonate (PS-TTC) and in-situ end group removal (Entry 2, Table 5, FIG. 5): Styrene (2.08 g, 20.0 mmol), AIBN (6.5 mg, 0.04 mmol), and TTC (127 mg, 0.4 mmol) were dissolved in THF (1.0 mL) in a 50 mL Schlenk flask. The reaction flask was degassed with three freeze-evacuate-thaw cycles, sealed and submerged in a preheated oil bath (70° C.) for 18 h. The reaction solution was cooled to room temperature. The reaction solution was divided into two fractions. The first fraction (little quantity) was precipitated in methanol, the precipitated polymer was collected by centrifugation and dried in vacuum at 40° C. until constant weight to yield a yellow color powder characteristic of polymer synthesized by RAFT polymerization using a TTC. The second fraction was subjected to a further reaction with TEB and O₂; TEB [2.0 mL, (1.0 Molar solution in THF), 2.0 mmol] was added directly to the polymerization mixture and the mixture was allowed to react for 1 min exposing to air till the decolorization (yellow to colorless). After decolorization, the reaction mixture was precipitated in methanol, and the precipitated polymer was collected by centrifugation and dried in vacuum at 40° C. until constant weight.

Representative procedure for preparation of Poly(vinyl acetate) with dithiocarbamate (PVAc-DTC) and in-situ end group removal (Entry 3, Table 5, FIG. 5): VA (2.58 g, 30.0 mmol), AIBN (19.50 mg, 0.12 mmol), and DTC (133.2 mg, 0.6 mmol) were dissolved in THF (1.5 mL) in a 50 mL Schlenk flask. The reaction flask was degassed with three freeze-evacuate-thaw cycles, sealed and submerged in a preheated oil bath (70° C.) for 18 h. The reaction solution was cooled to room temperature. The reaction solution was divided into two fractions. The first fraction (little quantity) was precipitated in n-hexane, the precipitated polymer was collected by centrifugation and dried in vacuum at 40° C. until constant weight to yield a light yellow color powder characteristic of polymer synthesized by RAFT polymerization using a DTC. The second fraction was subjected to a further reaction with TEB and O₂; TEB [3.0 mL, (1.0 Molar solution in THF), 3.0 mmol] was added directly to the polymerization mixture and the mixture was allowed to react for 1 min exposing to air till the decolorization (light yellow to colorless). After decolorization, the reaction mixture was precipitated in n-hexane, and the precipitated polymer was collected by centrifugation and dried in vacuum at 40° C. until constant weight.

Representative procedure for preparation of Poly(vinyl pyrrolidone) with xanthate (PNVP-XAN) and in-situ end group removal (Entry 4, Table 5, FIG. 5): NVP (2.22 g, 20.0 mmol), AIBN (13.3 mg, 0.08 mmol), and XAN (89 mg, 0.4 mmol) were dissolved in THF (2.0 mL) in a 50 mL Schlenk flask. The reaction flask was degassed with three freeze-evacuate-thaw cycles, sealed and submerged in a preheated oil bath (70° C.) for 6 h. The reaction solution was cooled to room temperature. The reaction solution was divided into two fractions. The first fraction (little quantity) was precipitated in diethyl ether, the precipitated polymer was collected by centrifugation and dried in vacuum at 40° C. until constant weight. The second fraction was subjected to a further reaction with TEB and O₂; TEB [2.0 mL, (1.0 Molar solution in THF), 2.0 mmol] was added directly to the polymerization mixture and the mixture was allowed to react for 1 min exposing to air. The reaction mixture was precipitated in diethyl ether, and the precipitated polymer was collected by centrifugation and dried in vacuum at 40° C. until constant weight.

TABLE 5
Results of Radical Induced Reaction of RAFT-synthesized Polymers with TEB and O₂:

| | RAFT-synthesized | M [symbol] (×10 [symbol] )/ | [RAFT polymer]/ | M [symbol] ( [symbol] 10 [symbol] )/PD [symbol] | M [symbol] (MALDI-TOF) | | End group |
|---|---|---|---|---|---|---|---|
| Entry | polymer [symbol] | PO [symbol] | [TEB] [symbol] | after treatment | Before | After | removal [symbol] |
| 1 | PMMA-DTE | 5.2/1.18 | 1: [symbol] | 5.1/1.24 | 5147 | [symbol] 095 | Complete |
| 2 | PS-TTC | 3.0/1.15 | 1:5 | 3.4/1.25 | 2 [symbol] 41 | 2497 | Complete |
| | | | | | | 4 [symbol] 4 | |
| 3 | PVAc-DTC | [symbol] .8/1.22 | 1:5 | 5.8/1.28 | 4282 | 3 [symbol] 38 | Complete |
| 4 | PNVP-XAN | 8.8/1.20 [symbol] | 1:5 | [symbol] .2/1.24 [symbol] | 27 [symbol] 0 | 2 [symbol] 89 | Complete |

[symbol]

PMMA-DTE: poly(methyl methacrylate) fitted with a dithiobenzoate; PS-TTC: Poly(styrene) fitted with trithiocarbonate; PVAc-DTC Poly(vinyl acetate) fitted with dithiocarbamate. PNVP-XAN Poly(vinyl pyrrolidone) with xanthate. [symbol]
Determined by GPC using tetrahydrofuran as the eluent and polystyrene as the standard. [symbol]
The TEB treatment with RAFT polymer were performed at 25° C. for 1 min. [symbol]
The extent of end group removal is characterized by ¹H NMR, NALDI-TOF and UV-visible spectroscopy. [symbol]
Determined by GPC using DM [symbol] as the eluent and polystyrene as standard. [symbol]
indicates data missing or illegible when filed

The elimination is a simple, highly efficient, and almost instantaneous procedure in which the thiocarbonylthio end group is removed using triethylborane (TEB) in open air (O₂). Trialkylborane has been used as a radical generator and utilized in radical polymerization, with the benefit that radicals can be generated and these corresponding eliminations can be triggered whatever the temperature considered. The discovery described herein leverages the unique property exhibited by TEB (5 eq.) to react with O₂ and generates very reactive ethyl radicals which in turn are used to add to the end-standing thiocarbonylthio group carried by RAFT-synthesized polymers and cleave the latter groups from the main chains in just seconds at room temperature, whatever the type of RAFT CTA considered: DTE, TTC, DTC, or XAN.

Recently, others have utilized the TEB/O₂ system to initiate RAFT polymerization. For polymerization to proceed until completion, they demonstrated that the ratio of TEB to CTA must be lower than to 2. In this Example, the TEB/O₂ system that produces ethyl radicals was not used to initiate RAFT polymerization but to neutralize in just seconds the terminal CTA group carried by RAFT polymers. PMMA-DTE was thus first prepared through conventional RAFT polymerization using 2-cyano-2-propyl benzodithioate as transfer agent and AIBN as radical generator, an excess of TEB was then added into the pink solution containing the just prepared PMMA-DTE in the presence of O₂. Upon addition of TEB, the strong pink color typical of DTE end group gradually became lighter, and then totally faded in less than one minute upon addition of when 5 eq. of TEB in the presence of O₂.

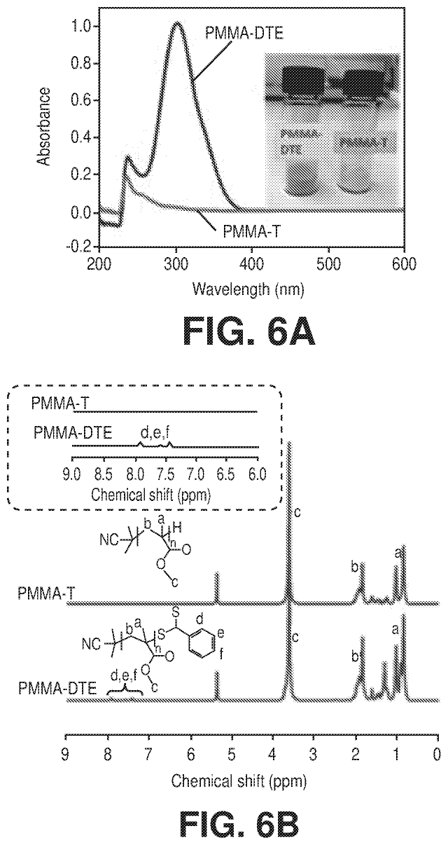

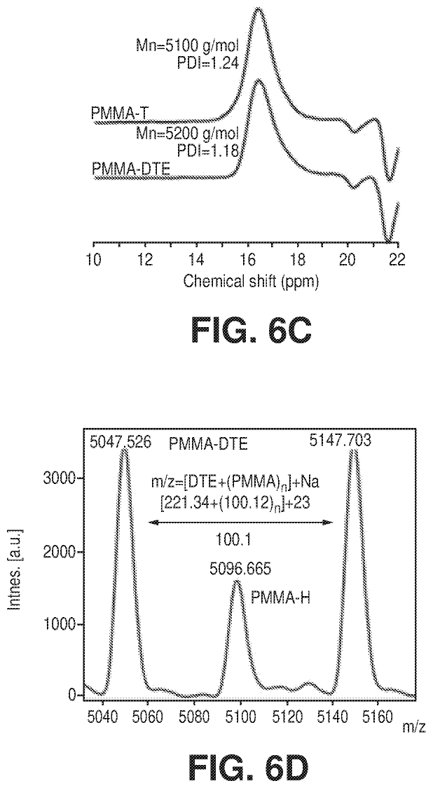

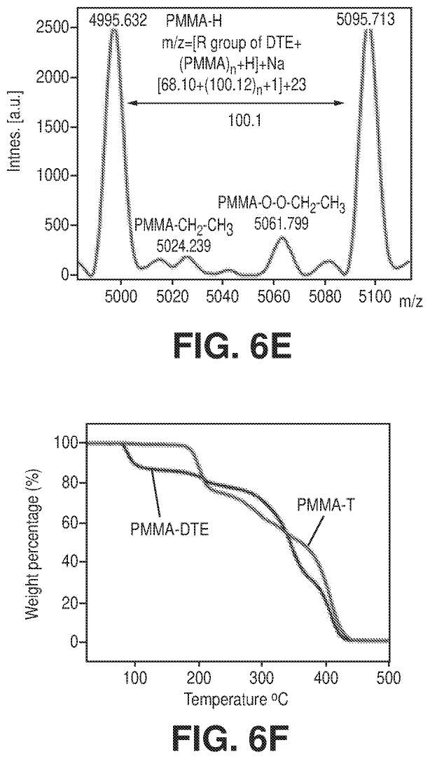

After precipitation, the white polymer PMMA-T recovered (after TEB/O₂ treatment) was submitted to different characterizations. First the strong absorbance UV-visible signal at 309 nm from the DTE group totally disappeared after treatment by TEB/O₂, indicating the complete removal of DTE (FIG. 6A). The ¹H NMR characterization also confirmed the disappearance of the terminal DTE group as no signal due to the aromatic protons was seen in the spectrum of TEB/O₂ treated PMMA-T sample (FIG. 6B), which was consistent with UV spectroscopic results. As for the GPC analysis of PMMA-T isolated after TEB/O₂ treatment, it exhibited exactly the same profile as that of PMMA-DTE, no doubling of molar mass part was observed, providing similar values of molar mass and polydispersity to those of the PMMA-DTE precursor (FIG. 6C). These results suggested that the original polymer backbone was untouched, and chain-chain coupling reactions did not occur during TEB/O₂ treatment.

To identify the kind of chemical group that could be end-fitting the polymer chains after such TEB/O₂ treatment, PMMA-DTE and PMMA-T were thus submitted to characterization by MALDI-TOF mass spectrometry. In the case of PMMA-DTE (FIG. 6D), the main population was end-capped with DTE group: its main peak showed a molar mass of m/z 5047 and satisfied the following structure: (100.12)₄₈+221.34+23 where the values of 100.12, 221.34, and 23 corresponded to the molar mass of the MMA monomeric unit, that of DTE, and of sodium respectively. A small population which was not capped with DTE, PMMA-H was also detected, with a main peak of molar mass of 5096 (m/z) corresponding to the following structure: (100.12)₅₀+68.10+1+23 where the values of 100.12 represented the molar mass of the MMA monomeric unit, 68.10 for 2-cyanoprop-2-yl which were fragments of DTE that triggered the RAFT radical polymerization, 1 for the hydrogen, and 23 for sodium, respectively. An incomplete functionalization of chains by CTA groups was indeed observed in RAFT polymerization especially at high conversion. After TEB/O₂ treatment, the MALDI-TOF results of obtained PMMA-T (FIG. 6E) showed only one main population (m/z 4995=(100.12)₄₉+68.10+1+23) corresponding to PMMA-H terminated with hydrogen. In addition, between the two main repeating signals, two minor populations were detected, corresponding to PMMA-CH₂CH₃ (m/z 5024), and PMMA-O—O—CH₂—CH₃ (m/z 5061) respectively. The former resulted from the recombination of ethyl radical Et. with the polymeric radical PMMA. and the latter was the recombination of peroxyl radical EtOO. with the polymeric radical PMMA.. It was interesting to emphasize the absence of any signal at m/z 5047 confirming the complete cleavage of the terminal DTE group, and mostly transformed into PMMA-H. Furthermore, the removal of end group (DTE) was remarkably reflected on the change of its thermal property. Its TGA analysis (FIG. 6F) showed an increased thermal stability whose degradation starts only above 180° C. In contrast, PMMA-DTE exhibited initial degradation at 84° C., losing up to 15 wt % at 180° C.

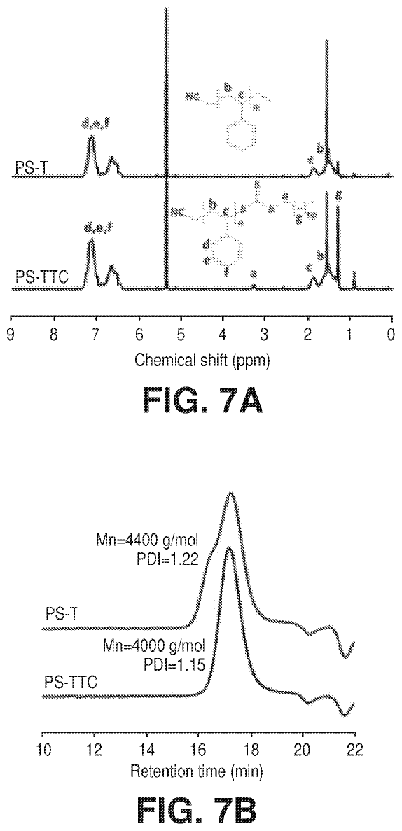

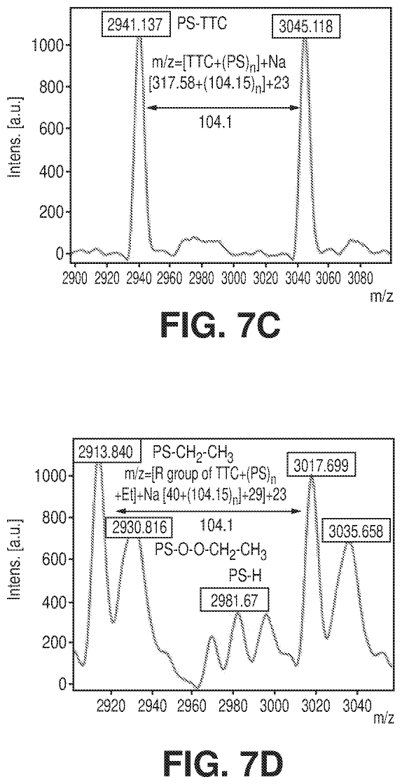

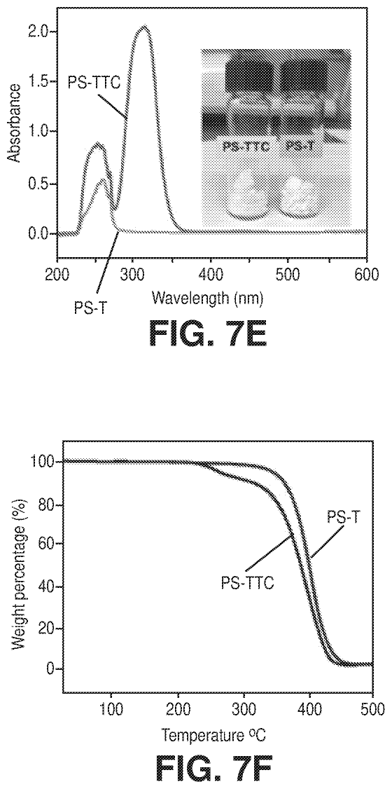

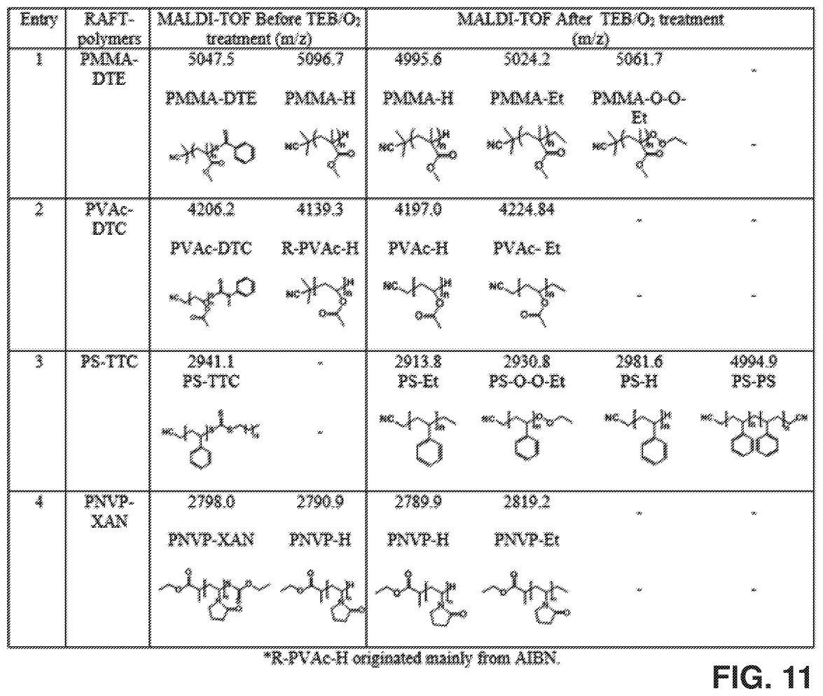

After succeeding to remove the DTE group from the RAFT-synthesized PMMA, three other polymer samples controlled by 3 different CTAs using RAFT methodology were prepared: polystyrene samples were obtained using TTC as controlling agent (PS-TTC), poly(vinyl acetate) samples using DTC (PVAc-DTC), and poly(vinyl pyrrolidone) samples using XAN (PNVP-XAN). These different CTAs allow excellent control of molar mass and afford samples of narrow polydispersity for these 3 families of polymers mentioned above (Table 5). The same reaction conditions as those described above were applied to check the versatility of TEB-oxygen based chemistry for chain end removal. In all cases, the color of the solutions submitted to TEB/O₂ treatment disappeared in less than one minute as in the PMMA-DTE after treatment by TEB in the air. All the recovered polymers were respectively characterized by UV, NMR, GPC, MALDI-TOF, and the results are summarized in Table 5. Based on the full characterization data provided in FIGS. 7A-7F, FIGS. 8A-8E, FIGS. 9A-9E, FIGS. 10A-10H, and FIG. 11, the end terminal CTA groups were totally removed in all cases, the colorless polymers were eventually isolated. Except for PS-T, all samples maintain their original molar masses and distributions.

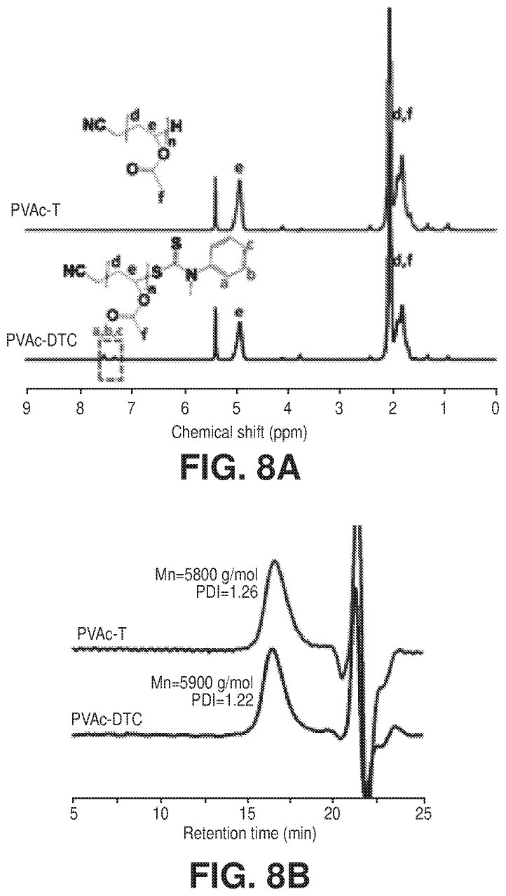

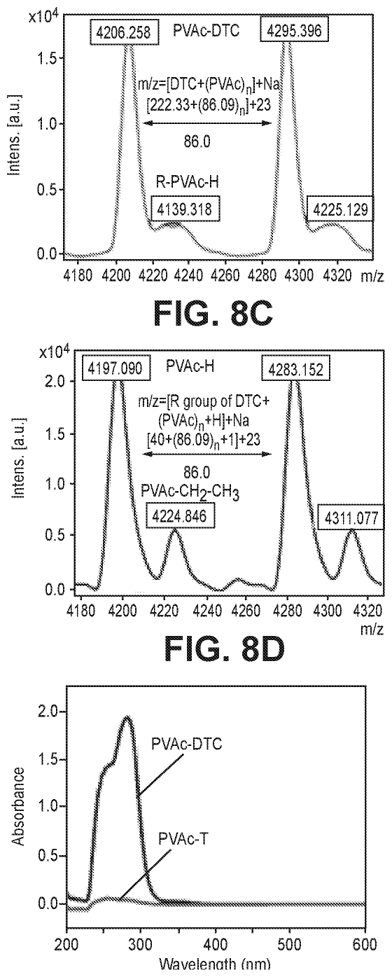

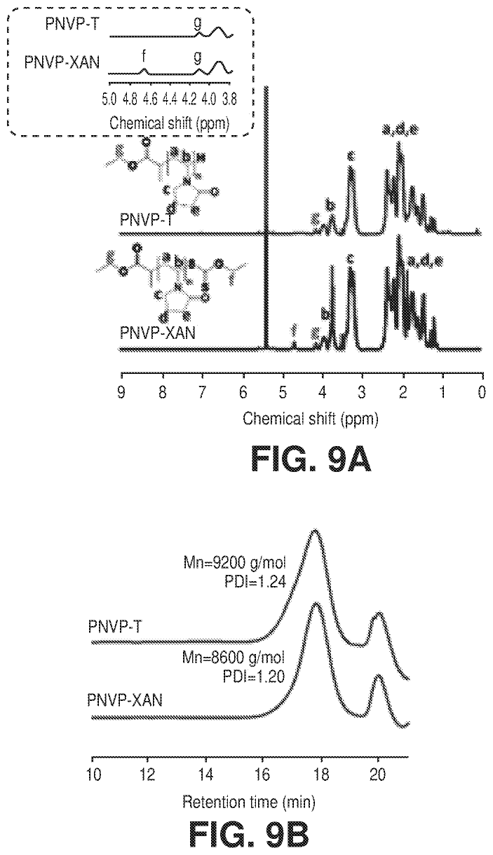

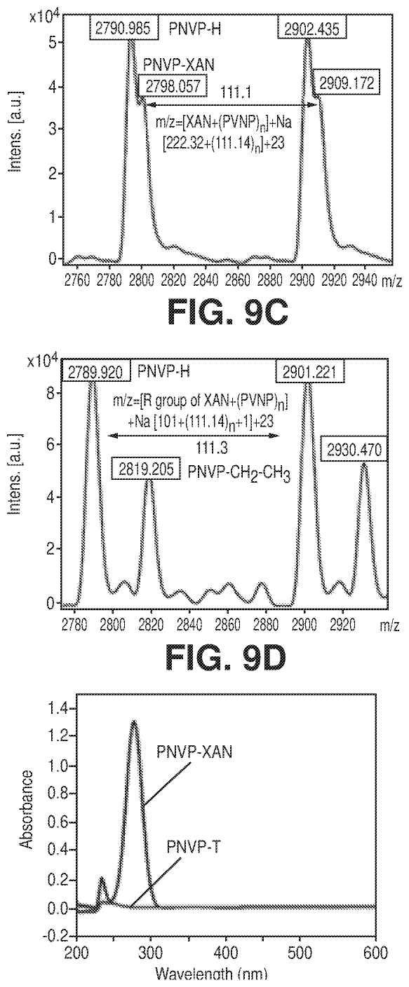

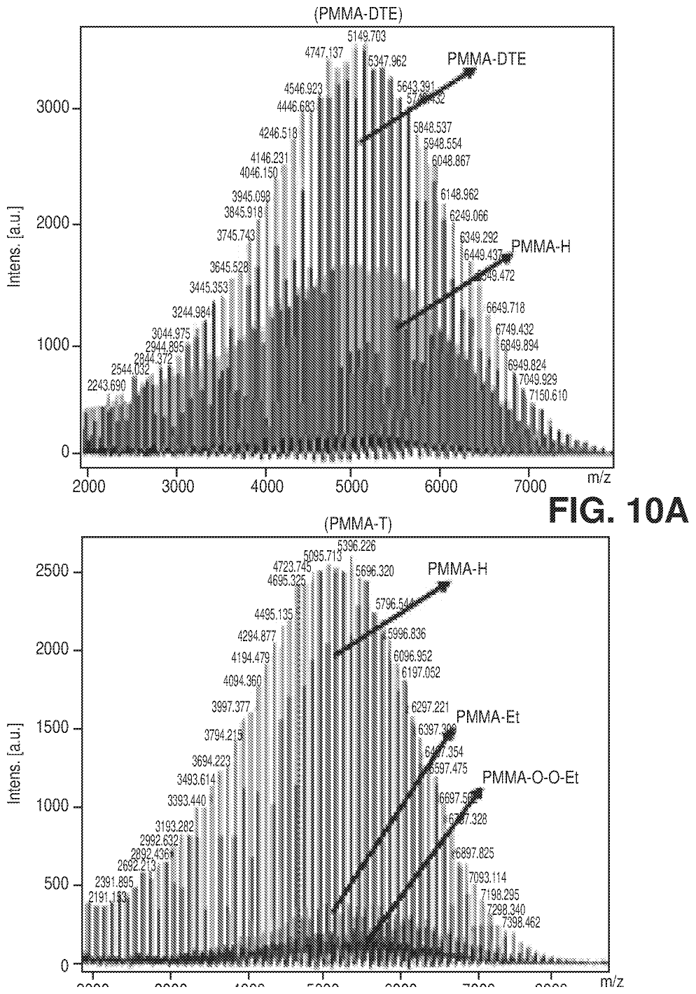

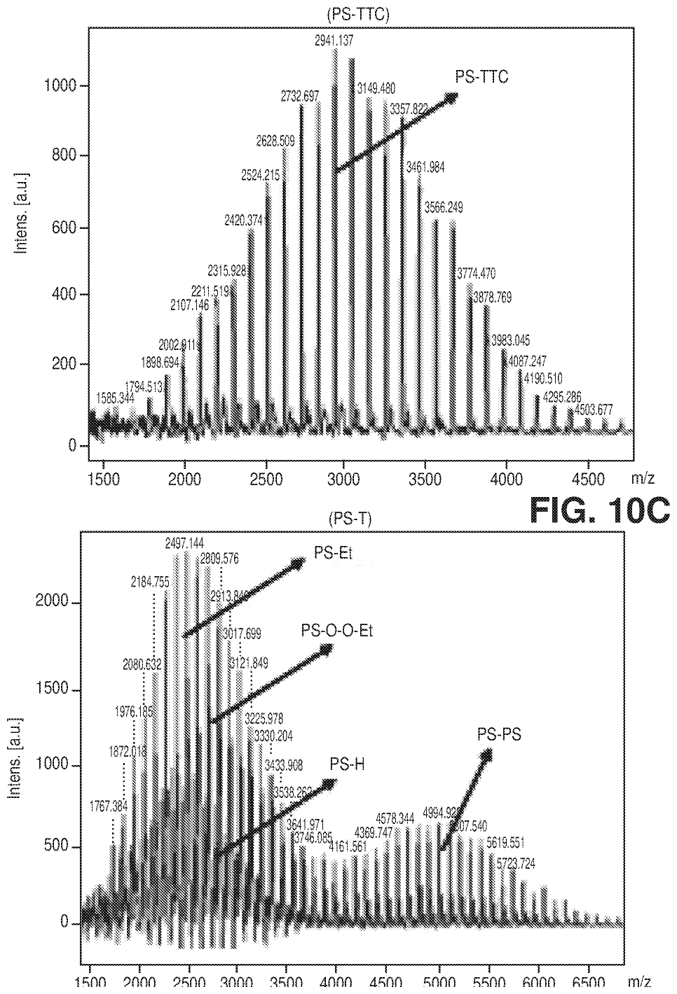

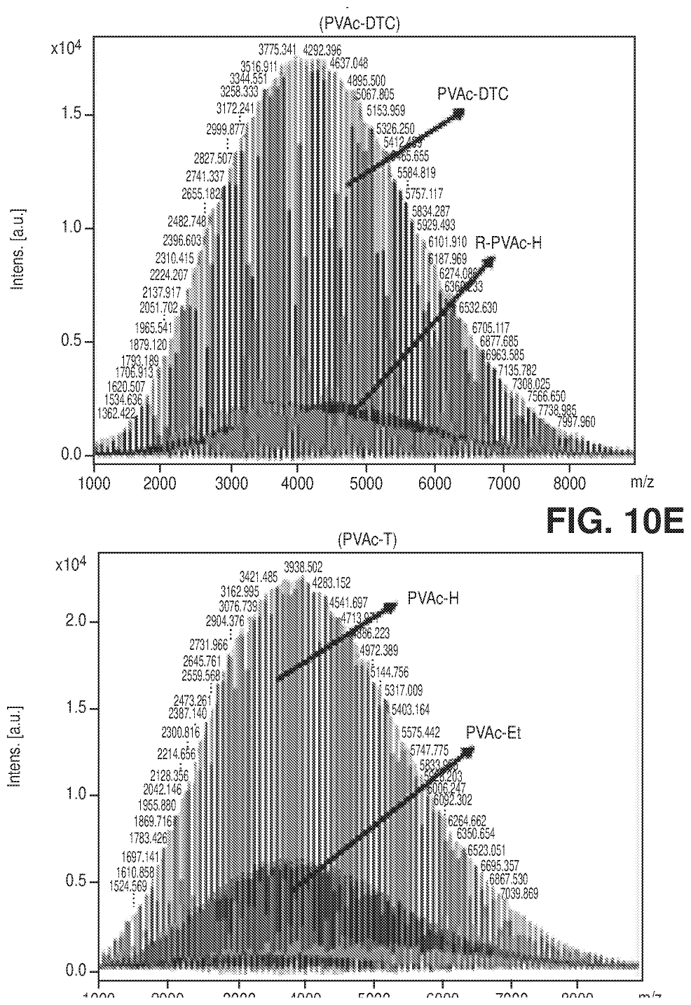

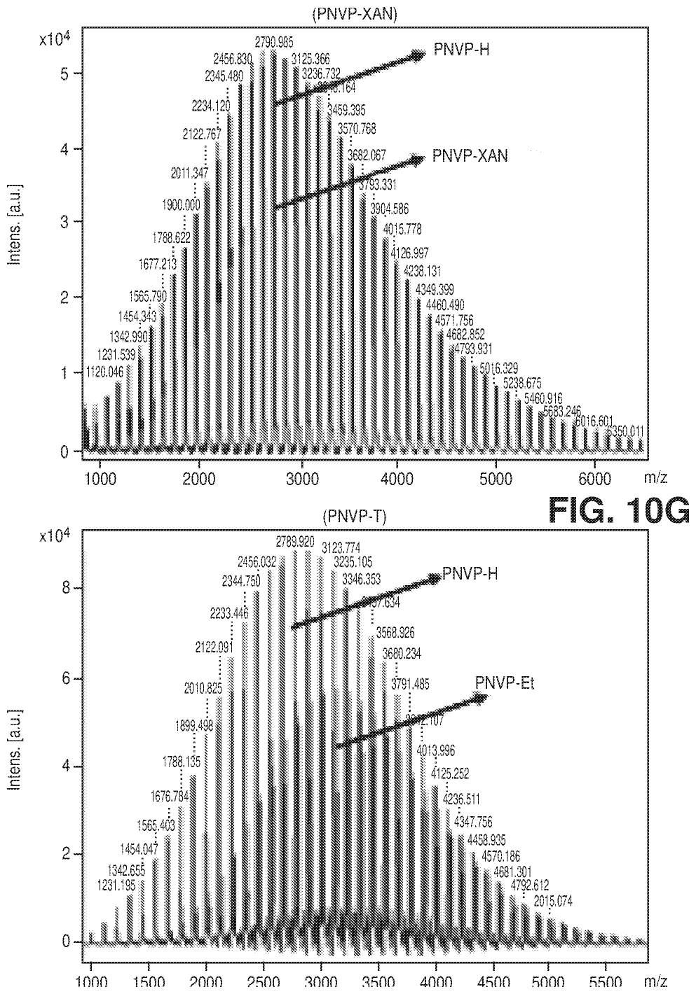

In the case of PS-T, a high molar mass bump was seen in the GPC traces (entry 2, Table 5, FIG. 7B), corresponding to double of the original molar masses which was also detected by MALDI-TOF (FIGS. 10A-10H), and indicating the occurrence of some polymer-polymer coupling during TEB/O₂ treatment. Indeed, polystyrene radicals are known to undergo such polymer-polymer coupling unlike tertiary radicals metharylate ones. Besides the peak due to PS—PS coupling (m/z 4994), the MALDI-TOF spectrum of PS-T showed three other populations: 1) PS—CH₂CH₃ (m/z 2913), 2) PS—OO—CH₂CH₃ (m/z 2930) and 3) PS—H (m/z 2981) which corresponded to 1) the recombination of Et. radicals with PS. radicals, 2) to the recombination of the peroxyl radical with the PS. radical and 3) to the dismutation of PS. with the above alkyl radicals, respectively. In contrast the MALDI-TOF spectrum of PS-TTC exhibited only one single population, the peak at 2941 (m/z) representing the expected structure: (104.15)₂₅+317.58+23, values of 104.15, 317.58 and 23 corresponding to the molar mass of the monomeric repeating unit, that of TTC and sodium respectively. In the case of PVAc-DTC the MALDI-TOF spectrum showed two populations, a major one filled with the DTC end group (FIG. 8C) and a minor one terminated with a H. The peak at m/z 4206 of the major population satisfied to the following structure: (86.09)₄₆+222.33+23 where the values 86.09, 222.33, and 23 corresponded to the molar masses of monomeric unit, of DTC, and of sodium respectively. As for the minor population NC—C(CH₃)₂—PVAc—H (m/z 4139), which originated from AIBN. After TEB/O₂ treatment, the PVAc-T submitted MALDI-TOF analysis showed one main population confirming the complete removal of the DTC thiocarbonylthio group (FIG. 8D). Here the values m/z 4197 corresponded to the following structure: (86.09)₄₈+40+1+23, and the values 86.09, 40, 1, and 23 corresponded to the VAc monomeric unit, the group of NCCH2, hydrogen, and sodium respectively. In addition, one minor population was also detected, corresponding to the recombination of the polymeric radical PVAc. with the ethyl radical: PVAc—CH₂—CH₃ (m/z 4224). Finally in the case of PNVP-XAN, the MALDI-TOF spectrum (FIG. 9C) exhibited the two main populations corresponding to the following two structures: PNVP-XAN (m/z 2798) and PNVP—H (m/z 2790). In the first case, the peak at m/z 2798 corresponded to the expected structure of: (111.14)₂₃+222.32+23, corresponding to molar masses of the monomeric units, of XAN, and of sodium respectively. After TEB/O₂ treatment, the MALDI-TOF spectrum of resulting polymer showed one major population corresponding to PNVP—H (FIG. 9D): its main peak at 2789 (m/z) satisfied the following structure (111.14)₂₄+101+1+23 which were the molar masses of the monomeric unit, of EtOCOCH(CH₃)-group of XAN that triggered the polymerization, of hydrogen, and of sodium respectively. In addition, one small populations was detected, corresponds to the coupling of the polymeric radical PNVP. with ethyl radical: PNVP—CH₂—CH₃ (m/z 2819).

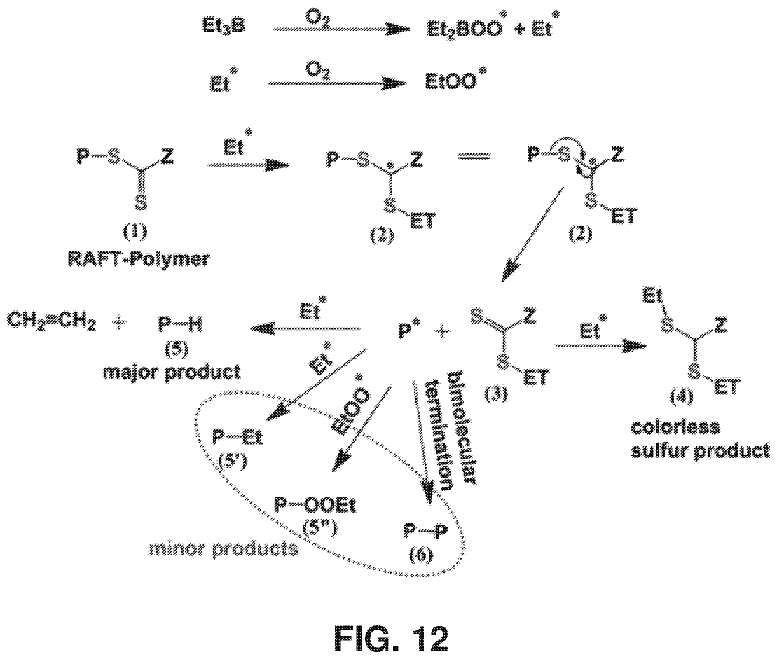

Based on the above characterizations, especially the MALDI-TOF data, a straightforward mechanism of elimination mechanism of CTA using TEB-oxygen is proposed in FIG. 12 based on CTA. In presence of O₂, TEB underwent autoxidation and produced ethyl radical (Et.) and boron peroxyl radical (Et₂BOO.). The highly active Et. radical immediately added to the —C═S bond of thiocarbonyl group (1) to generate an intermediate that underwent fragmentation and produced a polymer radical (2) and a new thiocarbonylthio compound (3). Most of these polymeric radicals P. underwent disproportionation upon reaction with Et′ radical to form P—H (5); a small fraction of them underwent recombination with Et. and its derivatized radical EtOO. to form P-Et (5′) and P—OOEt (5″). In the case of PS-CTA, some PS—PS coupling was obtained (6) due to the self-coupling of P.. The newly formed thiocarbonylthio compound (3) reacted further with ethyl radicals yielding thioethers (4), a colorless stable sulfur compound. In this method, TEB played the dual role of radical generator and H-donor that can remove the CTA group from the polymer synthesized by RAFT and eventually neutralize the residual thiocarbonylthio compound (3) into a colorless thioether.

In summary, a very simple and efficient method was demonstrated based on TEB/O₂ for the removal thiocarbonylthio end groups without altering the polymer carrying such end groups. Thanks to the high reactivity of ethyl radicals produced by autoxidation of TEB, this process completely removed all types of CTA end groups from RAFT-synthesized polymers in seconds under mild conditions without any other additives. The process can be applied at the end of any RAFT polymerization. This reported chemistry will remove obstacles to the development of commercial applications of RAFT polymerization.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A method of removing an end group from a polymer comprising contacting a polymer having a thiocarbonylthio end group with a borane compound in the presence of oxygen.

2. The method according to claim 1, wherein the polymer having a thiocarbonylthio end group is a polymer synthesized by reversible addition-fragmentation chain transfer (RAFT) polymerization.

3. The method according to claim 1, wherein the contacting is performed in situ, following a RAFT polymerization, or performed in a solution of RAFT-synthesized polymer.

4. The method according to claim 1, wherein the thiocarbonylthio end group has the following chemical formula:
—SC(═S)Z
wherein Z is selected from —R², —N(R²)₂, —SR², —OR², and —P(O)(OR²)₂; wherein each R² is independently selected from substituted and unsubstituted hydrocarbyls and substituted and unsubstituted heteroatom-containing hydrocarbyls.

5. The method according to claim 1, wherein the borane compound is trialkyl borane or triaryl borane.

6. The method according to claim 1, wherein the borane compound is selected from triethyl borane, tributyl borane, triisobutyl borane, trioctyl borane, and triphenyl borane.

7. The method according to claim 1, wherein the thiocarbonylthio end group is removed in its entirety from the polymer and replaced with a hydrogen.

8. The method according to claim 1, wherein the thiocarbonylthio end group is removed from the polymer and neutralized to a colorless product within about 1 min or less.

9. A method of polymerization, comprising:
contacting one or more monomers with an initiator and a chain transfer agent to form a polymer having a thiocarbonylthio end group in a reaction solution; and
contacting the polymer with an excess of a borane compound in the presence of oxygen to remove the thoicarbonylthio end group from the polymer.

10. The method according to claim 9, wherein the chain transfer agent is selected from dithioesters, trithiocarbonates, dithiocarbamates, and xanthates.

11. The method according to claim 9, wherein the polymer is formed by RAFT polymerization.

12. The method according to claim 9, wherein the thiocarbonylthio end group has the following chemical formula:
—SC(═S)Z
wherein Z is selected from —R², —N(R²)₂, —SR², —OR², and —P(O)(OR²)₂; wherein each R² is independently selected from substituted and unsubstituted hydrocarbyls and substituted and unsubstituted heteroatom-containing hydrocarbyls.

13. The method according to claim 9, wherein the borane compound is provided in molar excess of the chain transfer agent.

14. The method according to claim 9, wherein the ratio of the borane compound to the chain transfer agent is about 5:1.

15. The method according to claim 9, wherein the borane compound is selected from triethyl borane, tributyl borane, triisobutyl borane, trioctyl borane, and triphenyl borane.

16. The method according to claim 9, wherein the reaction solution is exposed to oxygen in air.

17. The method according to claim 9, wherein the thiocarbonylthio end group is removed from the RAFT polymer through a reaction that proceeds at about room temperature.

18. The method according to claim 9, wherein the method is performed without any intermediate step in which the polymer having the thiocarbonylthio end group is separated from other chemical species present in the reaction solution.

19. The method according to claim 9, wherein the thiocarbonylthio end group is removed in its entirety from the RAFT polymer and replaced with a hydrogen.

20. The method according to claim 9, wherein the thiocarbonylthio end group is removed from the polymer and neutralized to a colorless product within about 1 min or less.
